(19) United States
(12) Patent Application Publication
(10) Pub. No.: US 2024/0045398 A1
(43) Pub. Date: Feb. 8, 2024

(54) TECHNIQUES TO DETERMINE A HYBRID MANUFACTURING PLAN

(71) Applicant: Palo Alto Research Center Incorporated, Palo Alto, CA (US)

(72) Inventors: George Perry Harabin, Burlingame, CA (US); Morad Behandish, San Mateo, CA (US); Saigopal Nelaturi, Mountain View, CA (US)

(21) Appl. No.: 17/879,667

(22) Filed: Aug. 2, 2022

(51) Int. Cl. G05B 19/4099; B33Y 50/00; B29C 64/386

(52) U.S. Cl. CPC G05B 19/4099; B33Y 50/00; B29C 64/386; G05B 2219/49023; G05B 2219/32082

(57) ABSTRACT

The present disclosure provides techniques for determining a manufacturing plan. An example method includes obtaining an initial object definition describing an initial state of a manufacturing plan and obtaining a final object definition describing a target shape of an object to be formed through the manufacturing plan. The method also includes generating a tree comprising a plurality of nodes and edges. Each edge represents a selected manufacturing operation. The nodes include a parent node representing the initial object definition, intermediate child nodes representing an intermediate state of the object, and leaf nodes representing the target shape. The selected manufacturing operation applied at each edge may be a subtractive manufacturing (SM) operation or an additive manufacturing (AM) operation. The method also includes identifying a lowest cost manufacturing plan comprising a sequence of manufacturing operation connecting the parent node and one of the leaf nodes.

### TECHNICAL FIELD

Implementations of the present disclosure relate to hybrid manufacturing.

### BACKGROUND

Additive manufacturing (often known as 3D printing) enables the production of structures that are complicated in shape and not achievable by subtractive manufacturing methods. For example, hollow structures that are expensive or difficult to achieve in machining processes (i.e., removal of materials by turning, drilling, and milling) may be created layer by layer in additive manufacturing. Many forms of additive manufacturing make use of transforming matters from one state to another, such as from liquid to solid, by chemical reactions, or by heat (e.g., melting materials at specific locations and solidifying when cooled).

Some additive manufacturing techniques, such as material jetting or fused deposition modeling (FDM), require support structures to provide a substrate for overhangs (e.g., protrusions of the target shape, when sliced in the production direction, being lack of materials in the previous layer). For example, in material jetting, a layer of photo-sensitive polymer is jetted (similar to ink-jet printing) on a flat surface formed by the previous layer and cured into solid by ultra-violet (UV) light. The flat surface may include the model to be formed as well as support materials necessary to support the polymer in the current layer. The support materials can be removed upon completion, such as by melting or dissolving. In FDM, a molten string of filament is extruded and deposited by a hot-end nozzle into a sliced pattern in each layer, the molten string solidifies after exiting the hot-end nozzle. The same molten string is used to form the support structures for subsequent layers. Upon completion, the support structures can be manually removed in a post processing procedure that uses subtractive manufacturing. The manufacturing of a part using a combination of additive and subtractive techniques may be referred to as hybrid manufacturing (HM).

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a block diagram of a system to generate HM process plans for use in hybrid (additive and subtractive) manufacturing, in accordance with some embodiments of the present disclosure.

FIG. 2 is an illustration of the aggressive addition AM process, in accordance with some embodiments of the present disclosure.

FIG. 3 is an illustration of the conservative addition AM process, in accordance with some embodiments of the present disclosure.

FIG. 4 is an illustration of the aggressive subtraction SM process, in accordance with some embodiments of the present disclosure.

FIG. 5 is an illustration of the conservative subtraction SM process, in accordance with some embodiments of the present disclosure.

FIG. 6 is a diagram of a process for generating an HM process tree, in accordance with some embodiments of the present disclosure.

FIG. 7 is a process flow diagram for a method of generating a HM process plan, in accordance with some embodiments of the present disclosure.

FIG. 8 illustrates a diagrammatic representation of a machine in the example form of a computer system within which a set of instructions or processing logic, for causing the machine to perform any one or more of the methodologies discussed herein, may be executed.

Like numerals indicate like elements.

### DETAILED DESCRIPTION

The present disclosure provides various techniques for automated generation of hybrid additive and subtractive manufacturing process plans. Current hybrid manufacturing approaches generally leverage a two-step process in which an additive manufacturing (AM) step is used to generate a near-net shape, which is close to the final design and may include support structure, followed by a subtractive manufacturing (SM) post-processing step in which the support structure is removed and the part is brought to the net-shape part. However, the design space allowed by this two-step process is limited and may incur a large amount of material waste.

In accordance with embodiments of the present techniques, a hybrid manufacturing (HM) plan can be generated that incorporates additive and subtractive manufacturing (AM/SM) technologies in a multi-modal manufacturing process that combines the advantages of both manufacturing processes. The generated HM plan may be a multi-stage process with interleaved AM and SM operations to enable the cost-optimal manufacture of complex parts.

Embodiments of the present techniques can be used to automatically generate a tree graph that includes a plurality of nodes and edges, wherein each edge represents a selected manufacturing operation, and each node represents a shape of the object resulting from the manufacturing operation of the corresponding edge.

The root node represents the initial object definition, intermediate child nodes represent an intermediate state of the object, and leaf nodes representing the final object definition. The selected manufacturing operation applied at each edge may be selected from a plurality of predefined manufacturing operations, which include subtractive manufacturing operations and additive manufacturing operations. Each path through the tree from the root node to a leaf node represents a different manufacturing process plan, which may include interleaved AM operations and SM operations. The construction of the tree may be guided based on a cost estimate, which may be generated for each node. When the construction of the tree is complete, a lowest cost manufacturing plan may be identified by traversing the tree through a sequence of manufacturing operations connecting the parent node and one of the leaf nodes.

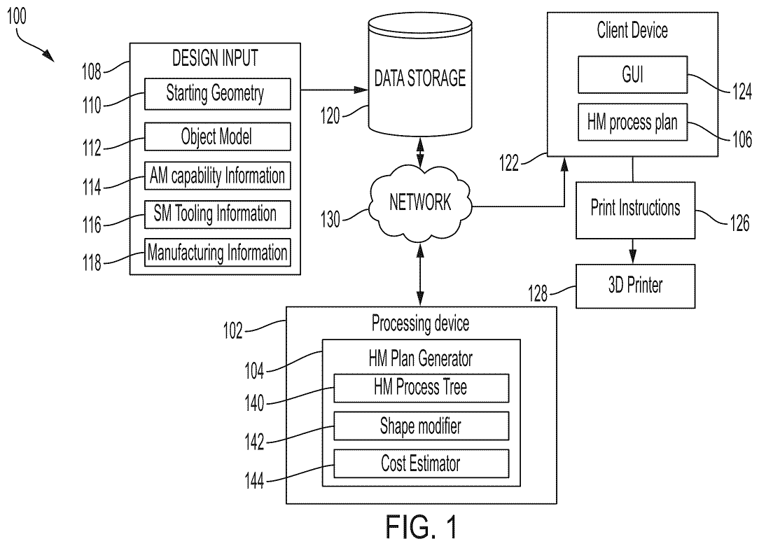

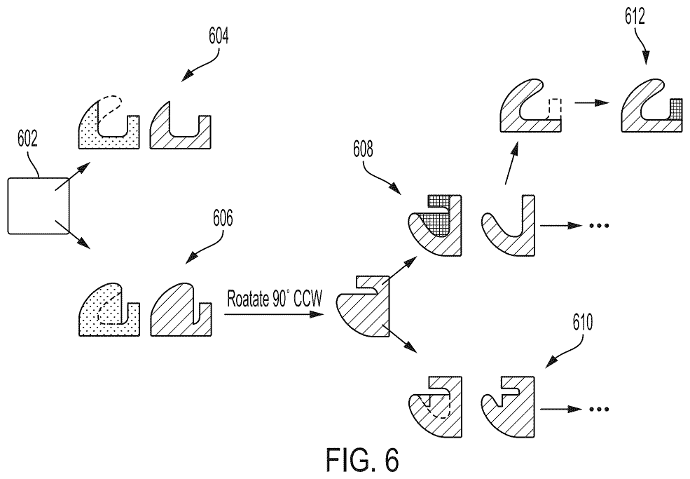

FIG. 1 illustrates a block diagram of a system to generate HM process plans for use in hybrid (additive and subtractive) manufacturing, in accordance with some embodiments of the present disclosure. As shown, the system 100 includes a processing device 102 with a HM plan generator 104 configured to generate a graph, referred to herein as HM process tree 140 or simply “tree” 140, describing potential HM process plans. An example of a portion of a HM process tree 140 is shown in FIG. 6.

The HM process tree 140 may be generated based at least in part on the design input 108, which may include starting geometry 110, an object model 112, AM capability information 114, and SM tooling information 116. The object model 112 describes the 3D object to be manufactured. More specifically, the object model 112 is an object definition describing a shape of the 3D object to be formed through the manufacturing plan. The shape of the object defined by the object model 112 may be referred to herein as the target shape. The object model 112 may be designed by a user using 3D modeling software. The object model 112 a computer-aided design (CAD) model (e.g., in AutoCAD™, Solidworks™, STEP, VRML, IGES, or DXF formats), a standard triangle language (STL) model or similar point cloud models (e.g., .obj, .x3d, files and the like), or files that can be converted to such files (e.g., .png image files with user-defined thickness information).

The starting geometry 110 describes an initial object definition describing an initial state of a manufacturing plan prior to the application of any manufacturing processes. For example, the starting geometry 110 may be an empty volume, in which case, the first manufacturing processes to be applied would be additive. The starting geometry 110 may also be a solid volume with a simple geometric shape, such as a rectangular block of material, in which case, the first manufacturing processes to be applied would be subtractive. Any suitable shape may be input by the user as the starting geometry 110.

The AM capability information 114 refers to features and limitations of the 3D printing system, such as height range of the 3D printing system (i.e., tallest printable part), minimum feature size, overhang constraints, and others. The SM tooling information 116 describes the features and capabilities of one or more SM tools. For example, the SM tooling information 116 may describe the geometry of various cutting tools that may be available for SM manufacturing operations.

The manufacturing information 118 may include data that enables the cost estimator 144 to compute a cost or cost estimate for each HM process plan. For example, the manufacturing information 114 may include business knowledge related to the cost of materials, the labor cost and time involved in various AM or SM processes, and others.

Some or all of the design input 108 may be received from a user such as an HM practitioner over a network 130 and stored to a data storage device 120. For example, design input 108 may be received from the client device 122, which can include a graphical user interface (GUI) 124 for providing input and viewing the output generated by the HM plan generator 104.

An example HM process tree 140 includes a root node, which represents the starting geometry 110, one or more leaf nodes, which represent the object model 112 (i.e., the as-designed finished object), and one or more intermediate nodes, which represent intermediate stages of the object's shape. Each node is connected by an edge which represents the manufacturing operation applied to the object shape at the parent node to arrive at the object shape of the child node. A path through the tree from the root node to a leaf node represents a sequence of manufacturing steps in the HM process plan 106. Although referred to herein as the HM process plan 106, it will be appreciated that, in some cases, the HM process plan 106 may include all AM manufacturing steps or all SM manufacturing steps depending on the details of a particular job, such as starting geometry and the object model 112. In other embodiments, the HM process plan 106 may alternate between AM manufacturing steps and SM manufacturing steps.

The HM plan generator 104 can include a shape modifier 142 that can be used to alter the shape of the 3D object in accordance with a specified AM or SM manufacturing process. More specifically, the shape modifier 142 modifies the shape of the 3D object at a parent node in accordance with the manufacturing operation described by the edge that connects the parent node to a child node to generate the shape at the resulting child node.

Each edge may describe a particular AM or SM operation, and may also include a rotation step that reorients the 3D object prior the performance of the operation. The process described at each edge specifies where to deposit material in the case of AM operations, or where to remove material in the case of SM operations. The material to be added or subtracted will depend on the current shape of the object at the parent node and the remainder of the target shape that is unfilled and/or the extra material that exists outside of the target shape.

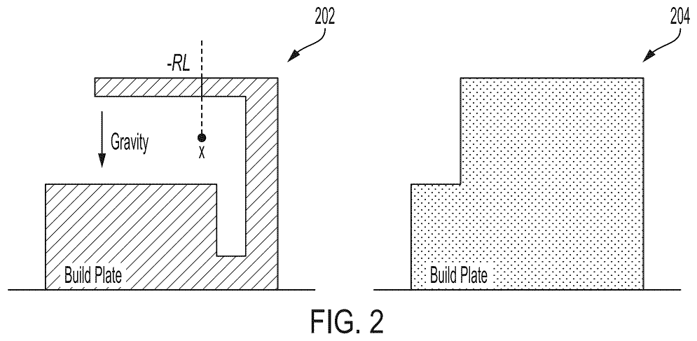

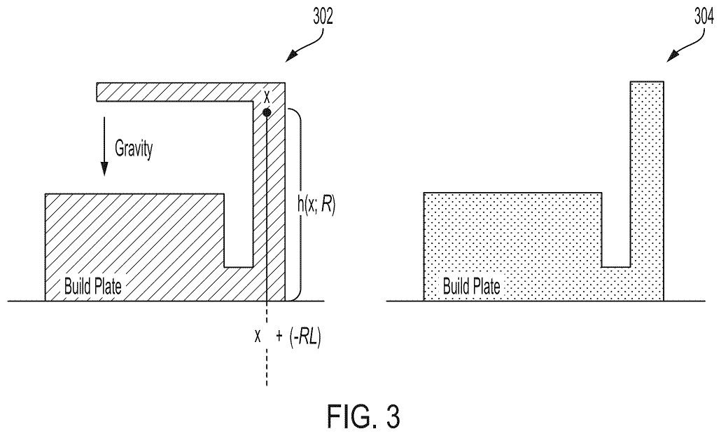

In some embodiments, the process performed at each edge may be selected from a limited set of predefined operations. For example, in some embodiments, there are two possible AM operations and two possible SM operations for the HM plan generator 104 to select from. The AM operations may be referred to as an aggressive addition (illustrated in FIG. 2) and a conservative addition (illustrated in FIG. 3). In the aggressive addition AM operations, material is deposited in the entire target shape (that is not already filled and lies within a region accessible to the AM tool) plus any support material that is needed to support the deposited material and that lies within a region accessible to the AM tool. In the conservative addition AM process, material is deposited in any part of the target shape (that is not already filled and lies within a region accessible to the AM tool) that would not require support material.

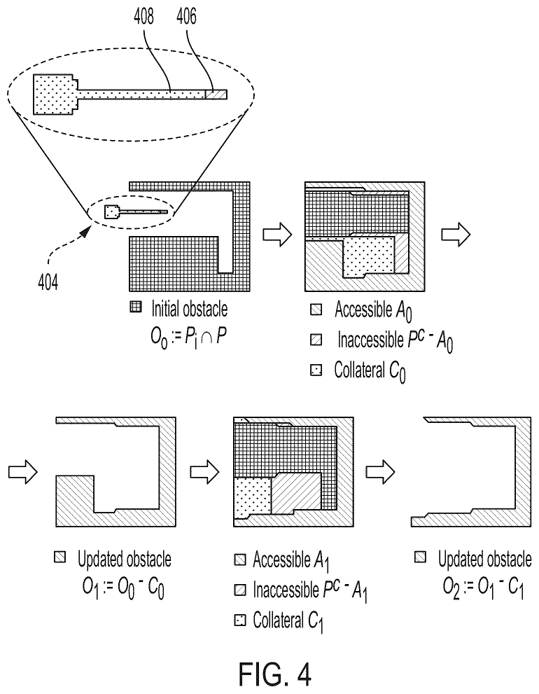

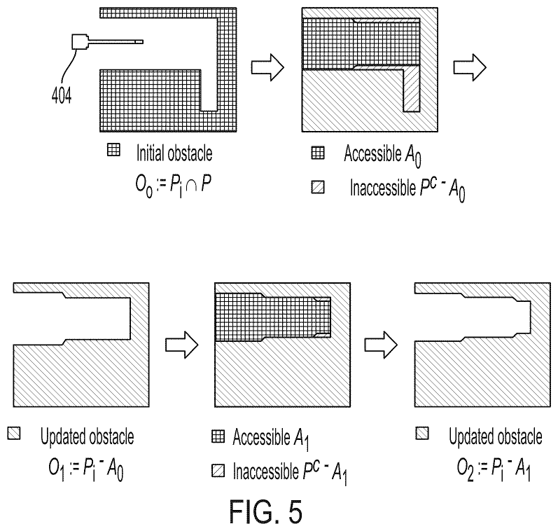

The SM processes may be referred to as an aggressive subtraction (illustrated in FIG. 4) and a conservative subtraction (illustrated in FIG. 5). In the aggressive subtraction SM process, all of the extra material outside of the target shape is removed even if material from the target shape is removed. In the conservative subtraction SM process, material outside of the target shape is removed only if it can be accessed without removing material inside of the target shape.

Starting at the root node, the HM plan generator 104 may generate a plurality of edges for each parent node, wherein each edge specifies an object orientation and one of the predefined AM or SM manufacturing processes. In some embodiments, the orientation and manufacturing processes may be selected randomly to explore the space of possible solutions. However, in some cases, HM plan generator may use the AM capability information 114 and/or SM tooling information 116 to identify infeasible or impractical solutions to limit the number of child nodes that may be generated for a particular parent node. For example, an infeasible orientation may be identified based on the 3D object being too tall for the 3D printer to deposit material. Another infeasible orientation may be one in which all or a large number of the surfaces are inaccessible. Various heuristics may be defined to determine which orientations and/or which AM or SM processes may be more beneficial any particular stage. For example, one heuristic may dictate that if the previous process was an AM process, then the HM plan generator 104 may be configured to only consider SM processes for the next set of edges, and vice-versa. However, it will be appreciated that in other embodiments, two or more AM processes and two or more SM processed may be performed in a row.

For each edge, the shape modifier 142 generates a new shape according to the specified operation and correlates that new shape to the new node. The new node may then become a parent node from which additional child nodes can be generated.

The HM plan generator 104 can include a cost estimator 144 used to compute an estimated cost to manufacture the 3D object. The cost estimate may be computed based at least in part on the manufacturing information 118, which may describe material cost, labor cost, and others. The cost estimate may be computed for an entire HM process plan to identify a lowest cost plan.

In some embodiments, the cost estimate is computed for each node during the generation of the tree. This estimate cost computed at each node is the estimated cost for the entire HM process plan, including manufacturing processes leading to the node and manufacturing processes have not been performed but may be added to the HM process plan to arrive at the target shape. The cost estimate may be used to determine whether to compute additional child nodes for that specific node. For example, if the cost estimate for a child node is above a threshold, the child node may be flagged and treated as a dead end, in which case the process may move to a different node to generate new branches of the tree. In this way, the over-all size of the resulting tree can be reduced, thereby saving processing resources and enabling the process to converge upon a solution more quickly.

The cost estimator 144 may also be used to generate a cost estimate for a full HM process plan, wherein each of the processes from the root node to the leaf node have been generated. This cost estimate may be computed after the generation of each leaf node and stored in association with the corresponding leaf node. In some embodiments, cost estimates for each leaf node may be computed after the final HM process tree 140 has been computed.

In some embodiments, the HM process tree 140 may be displayed to a user. For example, the HM process tree 140 may be sent to the client device 122 to be displayed using the GUI 124. This may allow the user to see the decisions made by the HM plan generator 104 and may enable the user to manually define new child nodes for further exploration of the solution space. In some embodiments, the user may receive one or more HM process plans 106 instead of or in addition to the full tree. For example, the user may receive a single HM process plan 106 that has been identified as the least costly, or a specified number of the least expensive HM process plans 106.

Once the user has a suitable HM process plan 106, the user may begin manufacturing the 3D object accordingly. For those steps involving AM manufacturing, the material addition for that stage of the process may be converted into printing instructions 126 and sent to a 3D printer 128 for printing. For example, a program referred to as a slicer may be used to transform the edge specification from a CAD or STL file to a G-code file.

Although the processing device 102 and the client device 122 are illustrated as two separate devices, in some cases, the processing device 102 and the client device 122 may be included in a same computational system (or two modules on a common computational platform). In some embodiments, the GUI 124 may be included as a component of the HM plan generator 104. In some cases, the client device 122 may be a consumer terminal (e.g., a personal computer, a smart phone, etc.) that enables a user to upload designs and relevant information to the data storage 120, and the processing device 102 may behave as a server performing requested services to generate the HM process tree 140 and/or HM plans 106 and present them via the network 130. It will be appreciated that other computing system configurations may be used to implement the techniques described herein without deviating from the scope of the present disclosure.

FIG. 2 is an illustration of the aggressive addition AM process, in accordance with some embodiments of the present disclosure. In the aggressive addition process, material is deposited in the entire target shape (that is accessible and not already filled) plus any support material needed to support the deposited material. For the sake of clarity, the example manufacturing processes of FIG. 2 is shown in two dimensions. However, it will be appreciated that the depicted process is an AM process performed in a 3-dimensional volume.

As discussed above, the operation performed at an edge of the tree graph is performed on the starting shape represented by the parent node, and the resulting shape is the shape represented by the child node. In the example of FIG. 2, the parent node is the root node, and the initial object shape is an empty build platform. FIG. 2 also shows a target shape 202 and a final object shape 204. The target shape 202 is the as-designed 3D object represented by the object model 112 (FIG. 1), while the final object shape 204 represents the shape at the child node obtained at the end of the aggressive addition operation. The build volume may be divided into a grid of voxels whose size may depend on the minimum printable volume capability of the 3D printer. Each voxel may be filled or unfilled. A filled voxel represents a volume in which material is to be deposited, and an unfilled voxel represents a volume in which no material is to be deposited.

The final shape 204 may be generated by performing a query at each voxel in the grid to determine whether there are filled voxels directly above the query voxel relative to the force of gravity. For each voxel, if there are filled voxels above it, the voxel is also identified as a filled voxel for purposes of generating the final shape 204. For example, as shown in FIG. 2, a query may be performed by drawing a line from the query voxel X upward (i.e., opposite to the force of gravity). If the line intersects the target shape 202 as shown FIG. 2, then voxel X is identified as a filled voxel in the final shape 304. However, if the line does not intersect any filled voxel, the query voxel would be identified as an unfilled voxel in the final shape 304. This process may be repeated for each voxel in the build volume.

FIG. 3 is an illustration of the conservative addition AM operation, in accordance with some embodiments of the present disclosure. In the conservative addition AM operation, material is deposited in any part of the target shape (that is accessible and not already filled) that would not require support material. For the sake of clarity, the example manufacturing processes of FIG. 3 are shown in two dimensions. However, it will be appreciated that the depicted process is an AM process performed in a 3-dimensional volume.

In the example of FIG. 3, the parent node is the root node, and the initial object shape is an empty build platform. FIG. 3 also shows a target shape 302 and a final object shape 304. The target shape 302 is the as-designed 3D object represented by the object model 112 (FIG. 1), while the final object shape 304 represents the shape at the child node obtained at the end of the conservative addition operation. As in FIG. 2, the build volume may be divided into a grid of filled voxels and unfilled voxels.

The final shape 304 may be generated by performing a query at each filled voxel in the target shape 302 to determine whether there are unfilled voxels directly below the query voxel relative to the force of gravity. For each queried voxel, if there are unfilled voxels below it, the voxel is also identified as an unfilled voxel for purposes of generating the final shape 304. For example, as shown in FIG. 2, a query may be performed by drawing a line from the query voxel X downward (i.e., in the same direction as the force of gravity). If the line intersects the target shape 302 at each voxel from the query voxel X down to the build platform as shown FIG. 3, then voxel X is identified as a filled voxel in the final shape 304. However, if the line intersects an unfilled voxel, the query voxel would be identified as an unfilled voxel in the final shape 304. This process may be repeated for each voxel in the build volume.

FIG. 4 is an illustration of the aggressive subtraction SM operation, in accordance with some embodiments of the present disclosure. In the aggressive subtraction SM operation, all of the material outside of the target shape is removed even if extra material is removed. The material outside of the target shape may be referred to as the targeted material. In some embodiments, the amount of extra material removed is minimized to only that material that must be removed to allow access to the targeted material. For the sake of clarity, the example manufacturing processes of FIG. 4 are shown in two dimensions. However, it will be appreciated that the depicted process is a SM process performed in a 3-dimensional volume.

In the example of FIG. 4, the parent node is the root node, and the initial object shape is a block of material coextensive with the outside envelope of the target shape. FIG. 4 also shows an initial obstacle, O₀, which is defined as the intersection of the shape of the 3D object at the parent node, Pᵢ, and the target shape, P. In this example, since the starting shape of the 3D object at the parent node is a simple block of material, the initial obstacle, O₀, is the same shape as the target shape, P.

FIG. 4 also shows the dimensions of the SM tool 404. In this example, the SM tool 404 is a rotary cutting tool such as a CNC rotary milling tool. However, any suitable cutting tool may be used. The SM tool 404 includes an active portion 406 that serves as the cutting surface and an inactive portion 408 that supports the active portion and allows it to be held. The final object shape is determined after a series of iterations in which the SM tool 404 is compared to the obstacle to determine what material is to be removed in order to access the targeted material.

In the first iteration, the SM tool 404 is compared to the initial obstacle, O₀, to determine what parts of the targeted material are accessible (accessible material, A₀), what parts of the targeted material are inaccessible, and what material would have to be removed to make the inaccessible material accessible (referred to herein as collateral material, C₀). The accessible material, A₀, is the material that can be removed by the active portion 406 without cause a collision (overlapping volumes) between the inactive portion 408 and the initial obstacle, O₀. The inaccessible material is material that cannot be removed by the active portion without causing a collision between the initial obstacle and any part of the tool. The inaccessible material can be identified by subtracting the accessible material, A₀, from the unfilled volume, P c (i.e., the inverse of the initial obstacle). The collateral material, C₀, can be identified by determining the areas of overlap between the SM tool 404 and the initial obstacle O₀ that occur as the active portion 406 of the SM tool 404 is scanned over the inaccessible material, P^{C}-A₀.

Next an updated obstacle, O₁, is formed by subtracting the collateral material, C₀, from the initial obstacle, O₀. The process performed above is then repeated to identify accessible material, inaccessible material, and collateral material. It can be seen that the updated obstacle allows for much more material to be accessed, but still blocks some material. The inaccessible material can be identified by subtracting the accessible area from the unfilled volume, P^{C}(i.e., the inverse of the updated obstacle). The collateral material can be identified by determining the areas of overlap between the SM tool and the initial obstacle that occur as the active portion of the SM tool is scanned over the inaccessible material.

The updated obstacle, O₁, is then updated again by subtracting the additional collateral material, C₁, from the updated obstacle, O₁, to form a new updated obstacle, O₂. At this stage, all of the targeted material (i.e., material that is not part of the target shape) has been removed while minimizing the amount of material that must be removed to provide access to the targeted material. Accordingly, the process then ends and the updated obstacle, O₂, becomes the new object shape for the child node. If not all of the targeted material had been removed, additional iterations would be performed.

FIG. 5 is an illustration of the conservative subtraction SM operation, in accordance with some embodiments of the present disclosure. In the conservative subtraction SM operation, any material outside of the target shape that can be accessed without removing material inside of the target shape is removed. As in FIG. 4, the material outside of the target shape may be referred to as the targeted material. For the sake of clarity, the example manufacturing processes of FIG. 5 are shown in two dimensions. However, it will be appreciated that the depicted process is an SM process performed in a 3-dimensional volume.

In the example of FIG. 5, the parent node is the root node, and the initial object shape is a block of material coextensive with the outside envelope of the target shape. FIG. 5 also shows an initial obstacle, O₀, which is defined as the intersection of the shape of the 3D object at the parent node, Pᵢ, and the target shape, P. In this example, since the starting shape of the 3D object at the parent node is a simple block of material, the initial obstacle, O₀, is the same shape as the target shape, P. The processes performed in relation to FIG. 5 uses the same SM tool 404 described in relation to FIG. 4.

The final object shape is determined after a series of iterations in which the SM tool 404 is compared to the obstacle to determine what material is to be removed in order to access the targeted material without removing any additional material.

In the first iteration, the SM tool 404 is compared to the initial obstacle, O₀, to determine what parts of the targeted material are accessible (accessible material, A₀), what parts of the targeted material are inaccessible. The accessible material, A₀, is the material that can be removed by the active portion 406 without cause a collision (overlapping volumes) between the inactive portion 408 and the initial obstacle, O₀. The inaccessible material is material that cannot be removed by the active portion without causing a collision between the initial obstacle and any part of the tool. The inaccessible material can be identified by subtracting the accessible material, A₀, from the unfilled volume, P^{C}(i.e., the inverse of the initial obstacle).

Next an updated obstacle, O₁, is formed by subtracting the accessible material, A₀, from the shape of the 3D object at the parent node, Pᵢ. The process performed above is then repeated to identify additional inaccessible material that cannot be removed.

It can be seen that the updated obstacle allows for more material to be accessed, but still blocks some material. The inaccessible material can be identified by subtracting the accessible area from the unfilled volume, P^{C}(i.e., the inverse of the updated obstacle). The updated obstacle, O₁, then updated again by subtracting the additional accessible material, Ai, from the shape of the 3D object at the parent node, Pᵢ, to form a new updated obstacle, O₂. At this stage, as much of the targeted material (i.e., material that is not part of the target shape) has been removed that can be removed without removing any additional material. Accordingly, the process then ends and the updated obstacle, O₂, becomes the new object shape for the child node. If more of the targeted material can been removed, additional iterations are performed.

FIG. 6 is a diagram of a process for generating an HM process tree, in accordance with some embodiments of the present disclosure. It will be appreciated that only part of the full HM process tree 600 is shown, and that several additional child nodes may be generated. Additionally, although the example manufacturing processes of FIG. 6 are shown in two dimensions, it will be appreciated that the depicted SM and AM processes are simulated for a 3-dimensional volume. In this example, the target shape is shown with the dotted line and the actual shape at each stage of the simulated manufacturing process is shown with a solid line.

In this example, the process for generating the example HM process tree 600 starts with a root node 602 that is an empty volume. Accordingly, the first set of child nodes will be connected to the root node 602 by edges that describe an AM operation. Child node 604 represents the object shape after applying the conservative AM operation, as described above in relation to FIG. 3. Child node 604 represents the object shape after applying the aggressive AM operation, as described above in relation to FIG. 2. Although only two nodes are shown below the parent node, it will be appreciated that several additional child nodes may be generated using different object orientations.

Since the actual object shape does not match the target shape, additional child nodes may be generated for each of child nodes 604 and 606. FIG. 6 shows additional child nodes 608 and 610 that are generated from child node 606 (which is a parent node with respect to nodes 606 and 608). The process for generating both child nodes 608 and 610 starts with rotating the object 90 degrees clockwise. The process also includes applying SM operations to the rotated object. Child node 608 represents the object shape after applying the aggressive SM operation, as described above in relation to FIG. 4. Child node 610 represents the object shape after applying the conservative SM operation, as described above in relation to FIG. 5. Again, it will be appreciated that several additional child nodes may be generated by orienting the 3D object differently.

Additional child nodes below nodes 608 and 610 may also be generated until the 3D object is complete (i.e., the final shape of the object matches the target shape) or until the cost estimates exceed a threshold cost set by the use. For example, the child node 612 may be formed below child node 608 by rotating the shape represented at child node 608 by 90 degrees clockwise and performing an AM operation. In this case, the aggressive AM operation and the conservative AM operation would yield the same resulting object shape. Additionally, now that the object shape matches the target shape, the child node 612 can be identified as a leaf node.

It will be appreciated that the HM process tree 600 shows a limited number of nodes and that various additional nodes may be generated for the full tree depending on the details of a specific implementation. For example, additional child nodes may be generated for child node 604, possibly resulting in additional leaf nodes.

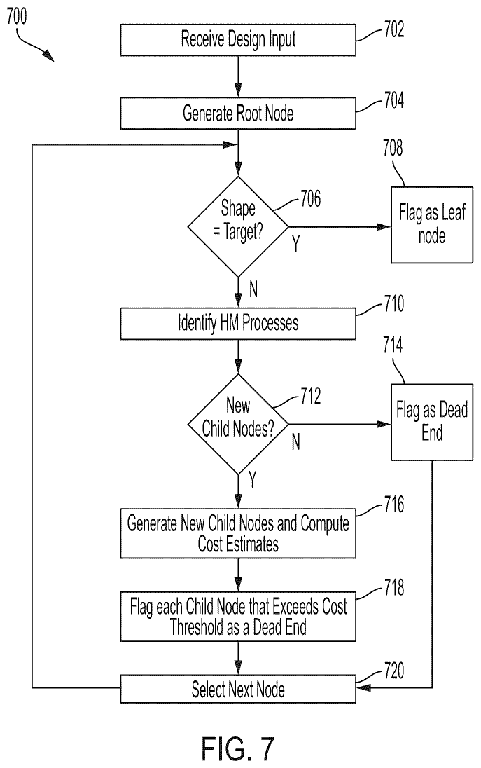

FIG. 7 is a process flow diagram for a method 700 of generating a HM process plan, in accordance with some embodiments of the present disclosure. The method 700 may be performed by hardware or a combination of hardware and software. For example, the method 700 may be performed by the HM plan generator 104 executing the processing device 102. The method may begin at block 702.

At block 702, design input is received. The design input may include any of the design input 108 described in relation to FIG. 1. For example, the design input may include some or all of the starting geometry 110, the object model 112, AM capability information 114, SM tooling information 116, manufacturing information 118, and others. Some of the design input may relate to system constraints that describe limitations of the 3D printer and/or the SM tools or systems available. For example, the system constraints may describe the dimensions of a build platform, a tallest printable height, a smallest feature size, and others. Some or all of the system constraints may be input manually by the user. In some embodiments, the user may select a type of 3D printer and the system constraints may be populated automatically. The system constraints may also indicate that the user has access to a CNC machine, a dremel kit, drill press, lathe, or other post printing capabilities. Some or all of the design input may be received from the user through a GUI (e.g., GUI 124) that will be used to display the results.

At block 704, the root node is generated. The root node may include shape information that comes from the starting geometry. In other embodiments, the shape information of the root node may be determined automatically. The shape information may be an empty volume (e.g., an empty build platform) or a solid block of material, for example.

At block 706, a determination is made regarding whether the current shape of the 3D object, i.e. the shape represented by the current node, is the same as the target shape within a specified threshold. It should be noted that the current shape of the 3D object is unlikely to match the target shape at the first iteration of the process. If the shapes are the same, the process advances to block 708 and the node is flagged as a leaf node. In some embodiments, the process may end at block 708 after the identification of a first leaf node, as described further below. In other embodiments, the process may continue and additional leaf nodes may be identified. Accordingly, although not shown, the process flow may advance from block 708 to bock 720. If the current shape of the 3D object is not the same as the target shape, the process flow advances to block 710.

At block 710, HM processes are identified. The HM process is associated with a specific edge within the HM process tree and is used to generate the connected child node. The HM process may include a specific AM or SM operation and orientation information describing an orientation of the 3D object used for performing the AM or SM operation. The AM operation and SM operations may be selected from a set of predefined operations, such as the aggressive addition, conservative addition, aggressive subtraction, and a conservative subtraction operations described above. In some embodiments, all of the feasible HM processes are identified and a child node is added to the tree for each one, resulting in a full layer of child nodes.

The HM processes may be identified automatically (i.e., without human involvement). For example, in some embodiments, a child node may be generated for each possible combination of the object's orientation, and each AM operation, and SM operation. Accordingly, identifying the HM process may simply involve incrementing through a predetermined list of HM operations. In some embodiments, heuristics are used to identify the HM process. For example, a heuristic may be used to identify one or more feasible or favorable orientations by determining the degree to which the relevant surfaces are accessible for addition or subtraction of material in a given orientation. Another heuristic may determine whether the HM process should include an AM or SM operation. For example, one example heuristic may dictate that an SM operation should always follow an AM operation, and vice-versa. Another example heuristic may determine whether AM or SM operation is more favorable based on a current ratio of the amount of missing material (i.e., the amount of material to be deposited) and the amount of extra material (i.e., the amount of material to be removed). The amount of missing material may be determined by subtracting the shape of the 3D object at the parent node from the target shape, and the amount of extra material may be determined by subtracting the target shape from the shape of the 3D object at the parent node. Various additional heuristics may be used.

In some cases, it may be possible that no feasible HM processes are identified for the current node. For example, this may be caused by a case where no HM processes are applicable, or where the HM processes do not result in a child node that is geometrically distinct from the parent node.

At block 712, a determination is made regarding whether additional child nodes exist for the current node, i.e., whether additional HM processes were identified at block 710. If no child nodes exist for the current node, the process flow advances to block 714, and the current node is flagged as a dead end. The process flow then advances from block 714 to block 720. If child nodes do exist for the current node, the process flow advances to block 716.

At block 716, the identified HM processes are used to generate the shape information for the child nodes, and the child nodes may be added to the HM process tree. Additionally, an estimated cost is computed for each of the newly generated child nodes. The estimated cost is the cost that will be incurred to manufacture the 3D object using the current HM process plan that the current node is a part of. This estimated cost may include the cost for HM processes that have been completed leading to the current node. For nodes that are not leaf nodes, the cost can also include the estimated cost for completing the manufacture of the 3D object. The estimated cost for completing the manufacture of the 3D object may be determined by computing an estimated AM cost of the material to be added to portions of the target shape that are unfilled, and computing an estimated SM cost of removing portions outside the target shape that have material deposited, and adding the estimated AM cost the estimated SM cost.

At block 718, a determination is made for each child node regarding whether the estimated cost for that child node is above a specified threshold. The threshold may be specified, for example, by the user as a way of limiting the growth of the HM process tree to those solutions that are cost effective. For each child node, if the estimated cost is above the threshold, that child node may be flagged as a dead end, meaning that no additional child nodes will be computed for that child node. The process flow may then advance to block 720.

At block 720, one of the nodes in the tree is identified as an exploration node, i.e., a node for which additional child nodes may be added. In some embodiments, the lowest cost node of the current layer that hasn't already been explored is identified as the exploration node. If there are no potential nodes in the current layer, for example, if all of the nodes are leaf nodes, or dead ends, or have already been explored, the process may traverse the tree back up to the previous layer, i.e., parent of the current layer of nodes. If there are no additional child nodes to be computed for that node, the process may climb up through the tree until a node is identified as having additional child nodes that are yet to be generated. Other embodiments are also possible. Once the new exploration node has been established, the process flow returns to block 706 with the new exploration node selected as the current node so that the selected node can either be identified as a leaf node or have new child nodes added.

The process described above may continue until a sufficient portion of the tree has been explored. The basis for determining whether to terminate the process may depend on the details of a specific implementation. For example, in some embodiments, the method may continue to generate child nodes until a leaf node is generated that has a cost estimate that is below the threshold. Once such a leaf is generated, the process ends and the path between the root node and the leaf node becomes the HM process plan 106 (FIG. 1), which may be provided to the user. In other embodiments, the process may be repeated until several leaf nodes have been generated, each of which represents a different HM process plan 106. In such cases, the lowest cost HM plan 106 or a specified number of lowest cost HM plans 106 may be provided to the user. Various other techniques are also possible.

It will be appreciated that embodiments of the method 700 may include additional blocks not shown in FIG. 7 and that some of the blocks shown in FIG. 7 may be omitted. Additionally, the processes associated with blocks 702 through 720 may be performed in a different order than what is shown in FIG. 7.

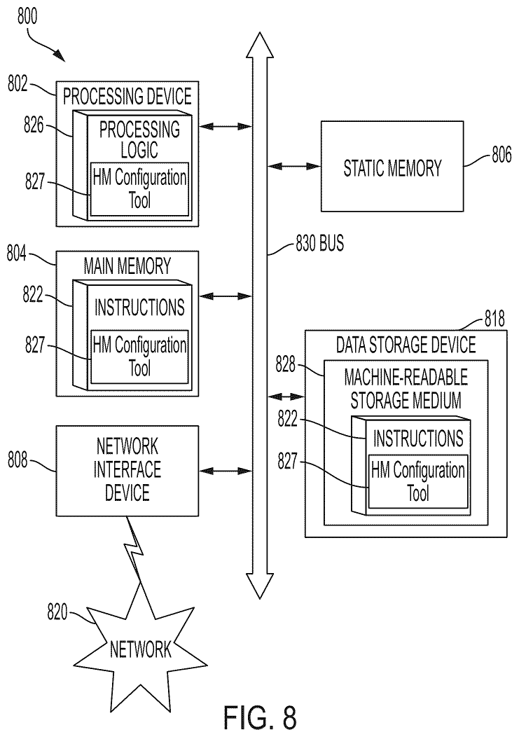

FIG. 8 illustrates a diagrammatic representation of a machine in the example form of a computer system 800 within which a set of instructions 822 or processing logic 826, for causing the machine to perform any one or more of the methodologies discussed herein, may be executed. In various embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet P^{C}, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 800 may be representative of a server computer system, such as system 100.

The exemplary computer system 800 includes a processing device 802, a main memory 804 (e.g., read-only memory (ROM), flash memory, dynamic random access memory (DRAM), a static memory 806 (e.g., flash memory, static random access memory (SRAM), etc.), and a data storage device 818, which communicate with each other via a bus 830. The processing logic 826 and/or the instructions 822 may include a HM plan generator 827 which can be configured to enable the processing device 802 to perform any of the tasks associated with the HM plan generator 104 of FIG. 1. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 802 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 may execute processing logic 826, which may be one example of system 100 shown in FIG. 1, for performing the operations and steps discussed herein.

The data storage device 818 may include a machine-readable storage medium 828, on which is stored one or more set of instructions 822 (e.g., software) embodying any one or more of the methodologies of functions described herein, including instructions to cause the processing device 802 to execute system 100. The instructions 822 may also reside, completely or at least partially, within the main memory 804 or within the processing device 802 during execution thereof by the computer system 800; the main memory 804 and the processing device 802 also constituting machine-readable storage media. The instructions 822 may further be transmitted or received over a network 820 via the network interface device 808.

While the machine-readable storage medium 828 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof

What is claimed is:

1. A method of generating a manufacturing plan, comprising:
obtaining an initial object definition describing an initial state of a manufacturing plan;
obtaining an object model describing a target shape of an object to be formed through the manufacturing plan;
generating, by a processing device, a tree comprising a plurality of nodes and edges, wherein each edge represents a selected manufacturing operation, wherein each node represents a shape of the object resulting from the selected manufacturing operation of a corresponding edge, and wherein the plurality of nodes comprises a parent node representing the initial object definition, intermediate child nodes representing an intermediate state of the object, and leaf nodes representing the target shape, and wherein the selected manufacturing operation applied at each edge is selected from a plurality of manufacturing operations, including a subtractive manufacturing (SM) operation and an additive manufacturing (AM) operation; and
identifying a lowest cost manufacturing plan comprising a sequence of manufacturing operations connecting the parent node and one of the leaf nodes.

2. The method of claim 1, wherein the lowest cost manufacturing plan comprises a sequence of alternating AM operations and SM operations.

3. The method of claim 1, wherein the plurality of manufacturing operations comprises an aggressive addition AM operation, a conservative addition AM operation, an aggressive subtraction SM operation, and a conservative subtraction SM operation.

4. The method of claim 3, wherein the aggressive addition AM operation comprises depositing material in all parts of the target shape plus any support material needed to support the deposited material.

5. The method of claim 3, wherein the conservative addition AM operation comprises depositing material in any part of the target shape that would not require support material.

6. The method of claim 3, wherein the aggressive subtraction SM operation comprises removing all material outside of the target shape even if material inside of the target shape is removed.

7. The method of claim 3, wherein the conservative subtraction AM operation comprises removing any material outside of the target shape that can be accessed without removing material inside of the target shape.

8. The method of claim 1, comprising computing an estimated cost at a specific node of the plurality of nodes and determining whether to compute additional child nodes for that specific node based on the estimated cost.

9. The method of claim 8, wherein the specific node represents a partially completed object, wherein computing the estimated cost comprises:
computing an estimated AM cost of the material to be added to portions of the target shape that are unfilled;
computing an estimated SM cost of removing portions outside the target shape that have material deposited; and
adding the estimated AM cost the estimated SM cost.

10. The method of claim 1 comprising:
generating 3D printing instructions corresponding to one of the manufacturing operations described by one of the nodes;
sending the 3D printing instructions to a 3D printer; and
printing a portion of the object.

11. An apparatus for generating a manufacturing plan, the apparatus comprising:
a memory;
a processing device operatively coupled to the memory, the processing device to:
obtain an initial object definition describing an initial state of a manufacturing plan;
obtain a final object definition describing a target shape of an object to be formed through the manufacturing plan;
generate a tree comprising a plurality of nodes and edges, wherein each edge represents a selected manufacturing operation, wherein each node represents a shape of the object resulting from the selected manufacturing operation of a corresponding edge, and wherein the plurality of nodes comprises a parent node representing the initial object definition, intermediate child nodes representing an intermediate state of the object, and leaf nodes representing the target shape, and wherein the selected manufacturing operation applied at each edge is selected from a plurality of manufacturing operations, including a subtractive manufacturing (SM) operation and an additive manufacturing (AM) operation; and
identify a lowest cost manufacturing plan comprising a sequence of manufacturing operation connecting the parent node and one of the leaf nodes.

12. The apparatus of claim 11, wherein the lowest cost manufacturing plan comprises a sequence of alternating AM operations and SM operations.

13. The apparatus of claim 11, wherein the plurality of manufacturing operations comprises:
an aggressive addition AM operation in which material is deposited in all accessible parts of the target shape plus any support material needed to support the deposited material;
a conservative addition AM operation in which material is deposited in any accessible part of the target shape that would not require support material;
an aggressive subtraction SM operation in which all material outside of the target shape is removed even if material inside of the target shape is removed; and
a conservative subtraction SM operation in which any material outside of the target shape that can be accessed without removing material inside of the target shape is removed.

14. The method of claim 1, wherein the processing device is further to compute an estimated cost at a specific node of the plurality of nodes and determine whether to compute additional child nodes for that specific node based on the estimated cost.

15. The apparatus of claim 14, wherein the specific node represents a partially completed object and, to compute the estimated cost, the processing device is to:
compute an estimated AM cost of the material to be added to portions of the target shape that are unfilled;
compute an estimated SM cost of removing portions outside the target shape that have material deposited; and
add the estimated AM cost and the estimated SM cost.

16. The apparatus of claim 11, wherein the processing device is further to:
generate 3D printing instructions corresponding to one of the manufacturing operations described by one of the nodes;
send the 3D printing instructions to a 3D printer; and
print a portion of the object.

17. A non-transitory computer-readable storage medium having instructions stored thereon that, when executed by a processing device, cause the processing device to:
obtain an initial object definition describing an initial state of a manufacturing plan;
obtain a final object definition describing a target shape of an object to be formed through the manufacturing plan;
generate a tree comprising a plurality of nodes and edges, wherein each edge represents a selected manufacturing operation, wherein each node represents a shape of the object resulting from the selected manufacturing operation of a corresponding edge, and wherein the plurality of nodes comprises a parent node representing the initial object definition, intermediate child nodes representing an intermediate state of the object, and leaf nodes representing the target shape, and wherein the selected manufacturing operation applied at each edge is selected from a plurality of manufacturing operations, including a subtractive manufacturing (SM) operation and an additive manufacturing (AM) operation; and
identify a lowest cost manufacturing plan comprising a sequence of manufacturing operation connecting the parent node and one of the leaf nodes.

18. The non-transitory computer-readable storage medium of claim 17, wherein the lowest cost manufacturing plan comprises a sequence of alternating AM operations and SM operations.

19. The non-transitory computer-readable storage medium of claim 17, wherein the plurality of manufacturing processes comprises:
an aggressive addition AM operation in which material is deposited in all parts of the target shape plus any support material needed to support the deposited material;
a conservative addition AM operation in which material is deposited in any part of the target shape that would not require support material;
an aggressive subtraction SM operation in which all material outside of the target shape is removed even if material inside of the target shape is removed; and
a conservative subtraction SM operation in which any material outside of the target shape that can be accessed without removing material inside of the target shape is removed.

20. The non-transitory computer-readable storage medium of claim 17, wherein the instructions further cause the processing device to compute an estimated cost at a specific node of the plurality of nodes and determine whether to compute additional child nodes for that specific node based on the estimated cost.
